(19) United States
(12) Patent Application Publication
(10) Pub. No.: US 2026/0172173 A1
(43) Pub. Date: Jun. 18, 2026

(54) SOUNDING REFERENCE SIGNAL RESOURCE CONFIGURATIONS

(71) Applicant: Nokia Technologies Oy, Espoo (FI)

(72) Inventors: Juha Pekka KARJALAINEN, Oulu (FI); Youngsoo YUK, Seoul (KR); Hiromasa UMEDA, Tokyo (JP)

(21) Appl. No.: 19/127,398

(22) PCT Filed: Nov. 7, 2022
(86) PCT No.: PCT/EP2022/080945

§ 371 Date: May 5, 2025

(51) Int. Cl. H04L 5/00

(52) U.S. Cl. CPC H04L 5/0048; H04L 5/0023; H04L 5/005; H04L 5/0053

(57) ABSTRACT

Example embodiments of the present disclosure relate to SRS resource configurations. In an example method, an apparatus receives, from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols. The apparatus transmits, to the network device, the simultaneous SRS transmission based on the configuration. In this way, a mechanism of UL SRS resource configurations and corresponding transmissions with multiple antenna ports may be defined and enhanced scheduling flexibility may be obtained.

### FIELD

Example embodiments of the present disclosure generally relate to the field of telecommunication, and in particular, to apparatuses, methods and a computer-readable storage medium for sounding reference signal (SRS) resource configurations.

### BACKGROUND

Wireless communication networks are widely deployed to provide various communication services such as voice, video, packet data, messaging, broadcast, and the like. A wireless communication network may include a number of base stations or node Bs that can support communication for a number of user equipments (UEs). As the demand for mobile broadband access continues to increase, the possibilities of interference and congested networks grows with more UEs accessing the long-range wireless communication networks and more short-range wireless systems being deployed in communities. Research and development continue to advance wireless communication technologies not only to meet the growing demand for mobile broadband access, but also to advance and enhance the user experience with mobile communications.

### SUMMARY

In general, example embodiments of the present disclosure provide a solution for SRS resource configurations.

In a first aspect, there is provided an apparatus. The apparatus comprises at least one processor and at least one memory storing instructions. When executed by the at least one processor, the instructions cause the apparatus at least to: receive, from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols; and transmit, to the network device, the simultaneous SRS transmission based on the configuration.

In a second aspect, there is provided an apparatus. The apparatus comprises at least one processor and at least one memory storing instructions. When executed by the at least one processor, the instructions cause the apparatus at least to: transmit, to a terminal device, a configuration of one or more uplink (UL) sounding reference signal (SRS) resources for simultaneous SRS transmission with a set of one or more antenna ports at the terminal device, wherein the set of one or more antenna ports associated with the one or more UL SRS resources correspond to one or more orthogonal frequency division multiplexing (OFDM) symbols; and receive, from the terminal device, the simultaneous SRS transmission based on the configuration.

In a third aspect, there is provided a method. The method comprises: receiving, at a terminal device and from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols; and transmitting, by the terminal device and to the network device, the simultaneous SRS transmission based on the configuration.

In a fourth aspect, there is provided a method. The method comprises: transmitting, by a network device and to a terminal device, a configuration of one or more uplink (UL) sounding reference signal (SRS) resources for simultaneous SRS transmission with a set of one or more antenna ports at the terminal device, wherein the set of one or more antenna ports associated with the one or more UL SRS resources correspond to one or more orthogonal frequency division multiplexing (OFDM) symbols; and receiving, at the network device and from the terminal device, the simultaneous SRS transmission based on the configuration.

In a fifth aspect, there is provided an apparatus. The apparatus comprises: means for receiving, from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols; and means for transmitting, to the network device, the simultaneous SRS transmission based on the configuration.

In a sixth aspect, there is provided an apparatus. The apparatus comprises: means for transmitting, to a terminal device, a configuration of one or more uplink (UL) sounding reference signal (SRS) resources for simultaneous SRS transmission with a set of one or more antenna ports at the terminal device, wherein the set of one or more antenna ports associated with the one or more UL SRS resources correspond to one or more orthogonal frequency division multiplexing (OFDM) symbols; and means for receiving, from the terminal device, the simultaneous SRS transmission based on the configuration.

In a seventh aspect, there is provided a non-transitory computer-readable storage medium comprising program instructions. The program instructions, when executed by an apparatus, cause the apparatus to perform at least the following: receiving, from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols; and transmitting, to the network device, the simultaneous SRS transmission based on the configuration.

In an eighth aspect, there is provided a non-transitory computer-readable storage medium comprising program instructions. The program instructions, when executed by an apparatus, cause the apparatus to perform at least the following: transmitting, by a network device and to a terminal device, a configuration of one or more uplink (UL) sounding reference signal (SRS) resources for simultaneous SRS transmission with a set of one or more antenna ports at the terminal device, wherein the set of one or more antenna ports associated with the one or more UL SRS resources correspond to one or more orthogonal frequency division multiplexing (OFDM) symbols; and receiving, at the network device and from the terminal device, the simultaneous SRS transmission based on the configuration.

In a ninth aspect, there is provided a computer program comprising instructions, which, when executed by an apparatus, cause the apparatus at least to: receive, from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols; and transmit, to the network device, the simultaneous SRS transmission based on the configuration.

In a tenth aspect, there is provided a computer program comprising instructions, which, when executed by an apparatus, cause the apparatus at least to: transmit, to a terminal device, a configuration of one or more uplink (UL) sounding reference signal (SRS) resources for simultaneous SRS transmission with a set of one or more antenna ports at the terminal device, wherein the set of one or more antenna ports associated with the one or more UL SRS resources correspond to one or more orthogonal frequency division multiplexing (OFDM) symbols; and receive, from the terminal device, the simultaneous SRS transmission based on the configuration.

In an eleventh aspect, there is provided an apparatus. The terminal device comprises: receiving circuitry configured to receive, from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols; and transmitting circuitry configured to transmit, to the network device, the simultaneous SRS transmission based on the configuration.

In a twelfth aspect, there is provided an apparatus. The network device comprises: transmitting circuitry configured to transmit, to a terminal device, a configuration of one or more uplink (UL) sounding reference signal (SRS) resources for simultaneous SRS transmission with a set of one or more antenna ports at the terminal device, wherein the set of one or more antenna ports associated with the one or more UL SRS resources correspond to one or more orthogonal frequency division multiplexing (OFDM) symbols; and receiving circuitry configured to receive, from the terminal device, the simultaneous SRS transmission based on the configuration.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, in which:

FIG. 1 illustrates an example of a network environment in which some example embodiments of the present disclosure may be implemented;

FIG. 2 illustrates a schematic diagram of UL SRS resource configurations with multiple antenna ports in a related solution;

FIG. 3 illustrates a flowchart illustrating a communication process in accordance with some example embodiments of the present disclosure;

FIG. 4A illustrates an example of a process flow for UL SRS resource configuration and transmission for codebook in accordance with some example embodiments of the present disclosure;

FIG. 4B illustrates a schematic diagram of an exemplary UL SRS resource configuration for codebook in FIG. 4A;

FIG. 4C illustrates a schematic diagram of another exemplary UL SRS resource configuration for codebook in FIG. 4A;

FIG. 5A illustrates an example of a process flow for UL SRS resource configuration and transmission for non-codebook in accordance with some example embodiments of the present disclosure;

FIG. 5B illustrates a schematic diagram of an exemplary UL SRS resource configuration for non-codebook in FIG. 5A;

FIG. 6A illustrates an example of a process flow for UL SRS resource configuration and transmission for antenna switching in accordance with some example embodiments of the present disclosure;

FIG. 6B illustrates a schematic diagram of an exemplary UL SRS resource configuration for antenna switching in FIG. 6A;

FIG. 6C illustrates a schematic diagram of another exemplary UL SRS resource configuration for antenna switching in FIG. 6A;

FIG. 7 illustrates a flowchart of an example method implemented at a terminal device in accordance with some embodiments of the present disclosure;

FIG. 8 illustrates another flowchart of an example method implemented at a network device in accordance with some embodiments of the present disclosure;

FIG. 9 illustrates a simplified block diagram of a device that is suitable for implementing some example embodiments of the present disclosure; and

FIG. 10 illustrates a block diagram of an example of a computer-readable medium in accordance with some example embodiments of the present disclosure.

Throughout the drawings, the same or similar reference numerals represent the same or similar elements.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
(c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as Long Term Evolution (LTE), LTE-Advanced (LTE-A), Wideband Code Division Multiple Access (WCDMA), High-Speed Packet Access (HSPA), Narrow Band Internet of Things (NB-IOT) and so on. Furthermore, the communications between a terminal device and a network device in the communication network may be performed according to any suitable generation communication protocols, including, but not limited to, the fourth generation (4G), 4.5G, the future fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR NB (also referred to as a gNB), a Remote Radio Unit (RRU), a radio header (RH), a remote radio head (RRH), a relay, a low power node such as a femto, a pico, and so forth, depending on the applied terminology and technology. In the following description, the terms “network device” and “network node” may be used interchangeably.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (loT) device, a watch or other wearable, a head-mounted display (HMD), a vehicle, a drone, a medical device and applications (for example, remote surgery), an industrial device and applications (for example, a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

NR Rel-17 specification provides support for single user downlink (DL) physical downlink shared channel (PDSCH) scheduling up to 8 layers (i.e. rank 8). However, Rel-15 UL SRS resource configuration with antenna switching can provide only support for UEs equipped with 4 reception (RX) antenna ports. In other words, even though an UE is equipped with 8 RX antenna ports, only four out of eight antenna ports can be used for DL channel state information (CSI) acquisition at gNB-side based UL SRS sounding. Obviously, this may lead to suboptimal use of potential merits of DL transmission (TX) precoding as well as RX processing, thus limiting system performance e.g. in terms of spectral efficiency and interference mitigation.

NR Rel-17 supports the following SRS time domain behaviors: periodic, semi-persistent, and aperiodic transmissions. With semi-persistent SRS transmission, medium access control (MAC) control element (CE) may be used to activate and deactivate a semi-persistent set of one or more SRS resources. While activated, semi-persistent UL SRS resource is transmitted with a configured periodicity and slot offset. As a result of this, more dynamic on/off control is enabled compared to periodic SRS resources which are configured only by radio resource control (RRC) signaling.

In Rel-17, depending on reported UE's antenna switching capability, the UE can be configured with the higher layer parameter usage in SRS-ResourceSet set as ‘antennaSwitching’. The UE may be configured with only one of the following configurations depending on the indicated UE capability supportedSRS-TxPortSwitch (‘t1r2’ for 1T2R, ‘t1r1-t1r2’ for 1T=1R/1T2R, ‘t2r4’ for 2T4R, ‘t1r4’ for 1T4R, ‘t1r6’ for 1T6R, ‘t1r8’ for 1T8R, ‘t2r6’ for 2T6R, ‘t2r8’ for 2T8R, ‘t4r8’ for 4T8R, ‘t1r1-t1r2-t1r4’ for 1T=1R/1T2R/1T4R, ‘t1r4-t2r4’ for 1T4R/2T4R, ‘t1r1-t1r2-t2r2-t2r4’ for 1T=1R/1T2R/2T=2R/2T4R, ‘t 1r1-t1r2-t2r2-t1r4-t2r4’ for 1T=1R/1T2R/2T=2R/1T4R/2T4R, ‘t1r1’ for T=1R, ‘t2r2’ for 2T=2R, ‘t1r1-t2r2’ for 1T=1R/2T=2R, ‘t4r4’ for 4T=4R, or ‘t1r1-t2r2-t4r4’ for 1T=1R/2T=2R/4T=4R), where T and R define the number of transmission antenna ports and reception antenna ports at the UE-side, respectively. The indicated UE antenna switching capability of ‘xTyR’ corresponds to a UE capable of SRS transmission on ‘x’ antenna ports over total of ‘y’ antenna ports, where ‘y’ corresponds to all or subset of UE's reception antenna ports.

In the case the SRS resources of a set are transmitted in the same slot, the UE is configured with a guard period of Y symbols, in which the UE does not transmit any other signal. The guard period is in-between the SRS resources of the set. For two SRS resource sets of an antenna switching located in two consecutive slots, if UE is capable of transmitting SRS in all symbols in one slot, a guard period of Y symbols exists between the last OFDM symbol occupied by the SRS resource set in the first slot and the first OFDM symbol occupied by the SRS resource set in the second slot. For the inter-set guard period, the UE does not transmit any other signal on any symbols of the interval if the interval between SRS resource sets is Y symbols. When both the SRS resource on all of the corresponding symbols prior to the gap and the SRS resource on all of the corresponding symbols after the gap are dropped due to collision handling, the gap period is also dropped with same priority and can be used for UL transmission. The UE shall expect to be configured with the same number of antenna ports for all SRS resources in the SRS resource set(s) with higher layer parameter usage set as ‘antennaSwitching’.

For 1T2R, 1T4R or 2T4R, or 1T6R or 1T8R, 2T6R, 2T8R, 4T8R, the UE shall not expect to be configured or triggered with more than one UL SRS resource set in the same slot with higher layer parameter usage set as ‘antennaSwitching’. For 1T=1R, 2T=2R or 4T=4R, the UE shall not expect to be configured or triggered with more than one UL SRS resource set in the same symbol with higher layer parameter usage set as ‘antennaSwitching’.

As discussed above, Rel-17 specification provides support for both symmetric and non-symmetric UL SRS resource antenna switching configurations xTyR, where symmetric ones having x=y=1,2,4 and non-symmetric ones where having x≠y, x=1,2,4 and y=1,2,4,8 by using one or more OFDM symbols.

In Rel-18, it is important to identify and specify necessary enhancements for uplink MIMO, while necessary enhancements on downlink MIMO that facilitate the use of large antenna array, not only for FR1 but also for FR2, would still need to be introduced to fulfil the request for evolution of NR deployments. Rel-18 will extend the specification support for symmetric antenna switching configuration by enabling support for x=y=8 with one or more OFDM symbols where different antenna ports are mapped to different symbols. Rel-18 will also extend the specification support for UL SRS resource configuration with usage codebook and non-codebook for 8 TX antenna ports using one or more symbols where different antenna ports are mapped to different OFDM symbols. However, it remains unclear how to enable UL SRS resource configuration for 8 TX antenna ports with usage of antenna switching and codebook as well as non-codebook with multiple OFDM symbols where different antenna ports are mapped to different symbols. Moreover, it remains unclear what is the UE transmission procedure for aforementioned UL SRS resource configurations.

There is a need to address problems of enabling resource configurations for a plurality of TX antenna ports (e.g., 2, 4, 6, 8 TX antenna ports) with multiple OFDM symbols as well as corresponding UE transmission procedures for UL SRS resource set(s) with usage of antenna switching, codebook as well as non-codebook. It should be noted that throughout the disclosure, the number of TX antenna ports is only for purpose of illustration, and is not intended for limiting.

Example embodiments of this disclosure relate to 3GPP NR physical layer design for MIMO enhancements in Rel-18 and beyond. More specifically, this disclosure targets to introduce new UL SRS resource configurations and UE transmission procedures for multiple (e.g., 8) TX antenna ports with multiple OFDM symbols. Example embodiments of the present disclosure provide a mechanism to solve the above discussed issues. In some example embodiments of the present disclosure, the UE may be configured with UL SRS resources for simultaneous SRS transmission with a set of one or more antenna ports at the UE. Here, the UE has a capability to transmit simultaneously uplink reference signal e.g. UL SRS (i.e. simultaneous SRS transmission in the disclosure) or channel associated with data or control e.g. physical uplink shared channel by using a set of one or more antenna ports associated with physical antenna arrangements (e.g. antenna elements or antenna panels or beams in spatial domain). The set of one or more antenna ports associated with the one or more UL SRS resources may correspond to one or more OFDM symbols. In this way, a mechanism of UL SRS resource configurations and corresponding transmissions with multiple antenna ports may be defined and enhanced scheduling flexibility may be obtained.

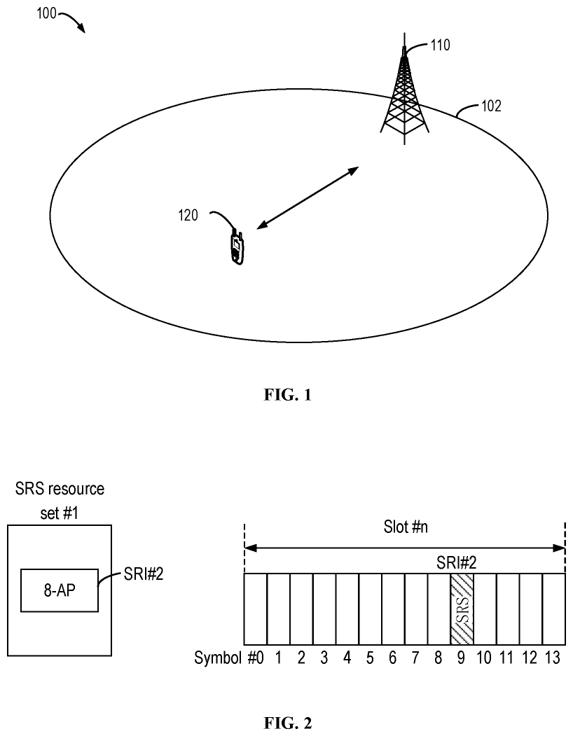

FIG. 1 illustrates an example of a network environment 100 in which some example embodiments of the present disclosure may be implemented. In the descriptions of the example embodiments of the present disclosure, the network environment 100 may also be referred to as a communication system 100 (for example, a portion of a communication network). For illustrative purposes only, various aspects of example embodiments will be described in the context of one or more terminal devices and network devices that communicate with one another. It should be appreciated, however, that the description herein may be applicable to other types of apparatus or other similar apparatuses that are referenced using other terminology.

The network device 110 can provide services to the terminal device 120, and the network device 110 and the terminal device 120 may communicate data and control information with each other. In some embodiments, the network device 110 and the terminal device 120 may communicate with direct links/channels.

In the communication system 100, a link from the network device 110 to the terminal device 120 is referred to as a downlink (DL), while a link from the terminal device 120 to the network device 110 is referred to as an uplink (UL). In downlink, the network device 110 is a transmitting (TX) device (or a transmitter) and the terminal device 120 is a receiving (RX) device (or a receiver). In uplink, the terminal device 120 is a transmitting (TX) device (or a transmitter) and the network device 110 is a RX device (or a receiver). It is to be understood that the network device 110 may provide one or more serving cells. As illustrated in FIG. 1, the network device 110 provides one serving cell 102, and the terminal device 120 camps on the serving cell 102. In some embodiments, the network device 110 can provide multiple serving cells. It is to be understood that the number of serving cell(s) shown in FIG. 1 is for illustrative purposes only without suggesting any limitation.

Communications in the network environment 100 may be implemented according to any proper communication protocol(s), comprising, but not limited to, cellular communication protocols of the fourth generation (4G) and the fifth generation (5G) and on the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

It is to be understood that the number of devices and their connection relationships and types shown in FIG. 1 are for illustrative purposes only without suggesting any limitation. The communication system 100 may comprise any suitable number of devices adapted for implementing embodiments of the present disclosure.

Higher peak data rate for UL could play a significant role in short-range applications such as home entertainment, video surveillance/monitoring in industrial/healthcare/safety, integrated access backhaul (IAB), and other applications where devices power/form-factor/cost are not as stringent as in traditional handheld devices. UL transmission with more than 4 TX antennal ports is useful to bridge the gap between DL and UL spectral efficiency, in both FR1 and FR2. Hence, there is strong need to develop methods and/or signaling solutions to overcome this problem for Rel-18 or beyond releases.

In RAN1 #110 meeting, it was agreed to use the existing value of the maximum number of SRS resource sets (as provided in Rel-17 antenna switching nTnR) for the maximum number of SRS resource sets for SRS with 8T8R with ‘antennaSwitching’. Additionally, in RAN1 #110 meeting, it was agreed that 8 TX antenna ports will be supported in Rel-18 for UL SRS with usage antenna switching. Based on this, the UE can be configured with one OFDM symbol for 8 TX UL SRS with antenna switching as illustrated in FIG. 2.

FIG. 2 illustrates a schematic diagram of UL SRS resource configurations with multiple antenna ports in a related solution. As shown in FIG. 2, in an example UL SRS resource configuration for SRS UE antenna switching for 8T8R, a UE may be configured with one UL SRS resource SRI #2 for simultaneous SRS transmission with 8 TX antenna ports (APs) at the UE. The 8 TX APs associated with the UL SRS resource SRI #2 in SRS resource set #1 may correspond to one OFDM symbol #9.

However, it remains for further study whether the UE can be configured with more than one OFDM symbols where different antenna ports are mapped to different symbols for 8 TX UL SRS usage for antenna switching. Moreover, it remains for further study whether one or more OFDM symbols can be configured also for UL SRS usage for codebook and non-codebook.

Furthermore, in RAN1 #110 meeting, it was agreed that Rel-18 shall support SRS resource set(s) with usage ‘non-Codebook’ having 8 UL SRS resources with one antenna port in each UL SRS resource in one or multiple OFDM symbols, where the maximum number of simultaneous SRS resources is determined via UE-capability signaling. In RAN1 #110bis meeting, it was agreed that 8TX codebook design shall support the following configurations: full coherent precoders with Ng=1; partial coherent precoders with Ng=2 and Ng=4; and non-coherent precoders.

In the following description, example embodiments related to UL SRS resource set configurations for simultaneous N-TX antenna port transmission with usage of antenna switching, codebook and non-codebook will be described below in detail in connection with FIGS. 2-8, where different antenna ports may be configured with different OFDM symbols. Moreover, example embodiments related to UE UL SRS resource configuration transmission procedures for antenna switching, codebook and non-codebook will be described below in detail.

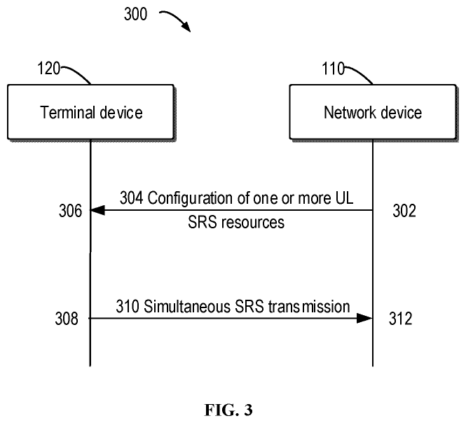

FIG. 3 illustrates a flowchart illustrating a communication process 300 in accordance with some example embodiments of the present disclosure. For ease of understanding, the communication process 300 will be described with reference to FIG. 1. It would be appreciated that although the communication process 300 has been described referring to the network environment 100 of FIG. 1, this communication process 300 may be likewise applied to other similar communication scenarios.

As illustrated in FIG. 3, the network device 110 transmits (302), to the terminal device 120, a configuration 304 of one or more UL SRS resources for simultaneous SRS transmission with a set of one or more antenna ports at the terminal device 120. The set of one or more antenna ports associated with the one or more UL SRS resources correspond to one or more OFDM symbols. The terminal device 120 receives (306) the configuration 304 and transmits (308) the simultaneous SRS transmission 310 to the network device 110 based on the configuration 304. The network device 110 receives (312) the simultaneous SRS transmission 310 from the terminal device 120 based on the configuration 304.

In some embodiments, the terminal device 120 may transmit, to the network device 110, capability information related to the simultaneous SRS transmission on the set of one or more antenna ports at the terminal device 120. The network device 110 may determine the configuration 304 based on the capability information received from the terminal device 120.

In some embodiments, the terminal device 120 may be configured with the one or more UL SRS resources associated with two or more antenna ports for codebook-based simultaneous transmission. For example, the terminal device 120 may be configured with one or more UL SRS resource sets for codebook-based transmission and the configuration 304 may comprise one or more UL SRS resources where each resource is associated with SRS resource indicator (SRI) in the one or more UL SRS resource sets. In some embodiments, each UL SRS resource among the one or more UL SRS resources may correspond to a different OFDM symbol among the one or more OFDM symbols. In other words, transmissions using different resources may be performed on different OFDM symbols with different antenna ports.

In some embodiments, one or more resource sets can be configured with one or more SRS resource where each SRS resource may have same or different number of antenna ports for example to support different UL TX full power modes, e.g. full power model and/or full power mode 2.

In some embodiments, the set of one or more antenna ports may comprise at least one antenna port coherency group for simultaneous transmission. Each antenna port coherency group for simultaneous transmission may be associated with a UL SRS resource among the one or more UL SRS resources. It is assumed that different antenna ports within the same antenna port coherency group should be coherent with each other while antenna ports from different antenna port coherency groups may be non-coherent with each other. Alternatively, some antenna ports from different antenna port coherency groups may also be coherent with each other.

In some embodiments, the terminal device 120 may transmit antenna port group coherency information to the network device 110. The network device 110 may determine the configuration 304 based on the capability information and antenna port group coherency information received from the terminal device 120. In some embodiments, the antenna port group coherency information may comprise a number of antenna port coherency groups. Alternatively or additionally, the antenna port group coherency information may comprise a number of antenna ports per antenna port coherency group.

In some embodiments, the terminal device 120 may apply full coherency between antenna ports within the same antenna port coherency group for codebook-based precoding. In some embodiments, the terminal device 120 may apply non-coherency between antenna ports between different antenna port coherency groups for codebook-based precoding.

In some embodiments, the terminal device 120 may be configured with multiple UL SRS resources with one or more resource sets for non-codebook-based transmission. The group of single antenna port UL SRS resources may correspond to one or more OFDM symbols, where different antenna ports are associated with different OFDM symbols. For example, the terminal device 120 may be configured with one or more UL SRS resource sets for non-codebook-based transmission and the configuration 304 may comprise multiple UL SRS resources associated with multiple SRS resources indicators (SRI)s in the one or more UL SRS resource sets. In some embodiments, the multiple single antenna port UL SRS resources may comprise at least one UL SRS resource group. Each UL SRS resource group among the at least one UL SRS resource group may correspond to a different OFDM symbol among the plurality of OFDM symbols. In other words, simultaneous transmissions using different single antenna port resources from the same UL SRS resource group may be performed on the same OFDM symbol while simultaneous transmissions using different single antenna port resources from different UL SRS resource groups may be performed on different OFDM symbols, where antenna ports used for the transmission are different with respect to another group of UL SRS resources. In some embodiments, each UL SRS resource among the plurality of UL SRS resources may be associated with a single antenna port among the set of one or more antenna ports. In some embodiments, the terminal device 120 may apply full coherency between antenna ports within the set of one or more antenna ports for non-codebook-based precoding.

In some embodiments, the terminal device 120 may transmit antenna port group coherency information to the network device 110. The network device 110 may determine the configuration 304 based on the capability information and antenna port group coherency information received from the terminal device 120. In some embodiments, the antenna port group coherency information may at least comprise a maximum coherency validity time in unit of OFDM symbols. The maximum coherency validity time may be a time period between a first OFDM symbol and a last OFDM symbol corresponding to UL SRS resources associated with antenna ports with full coherency in-between. For example, if the antenna port group coherency information indicates that the maximum coherency validity time is T_maxC OFDM symbols, it means that when the terminal device 120 is configured with UL SRS resources for simultaneous SRS transmissions with the set of one or more antenna ports at terminal device, antenna ports within the set of one or more antenna ports may have full coherency with each other if the configured UL SRS resources correspond to OFDM symbols that do not exceed the number of T_maxC.

In some embodiments, the number of UL SRS resource groups may be less than the number (e.g., T_maxC) of OFDM symbols in the maximum coherency validity time. Remaining OFDM symbols in the maximum coherency validity time except for OFDM symbols corresponding to the at least one UL SRS resource group may be available for transmission of uplink or downlink information, where uplink or downlink information may be associated with data signal or control signal or reference signal. In other words, there is no scheduling restriction on the remaining OFDM symbols for the terminal device 120.

In some embodiments, a subset of UL SRS resources among the multiple UL SRS resources may be configured with transmission occasions outside of the number of OFDM symbols in the maximum coherency validity time. In such situations, the terminal device 120 may not to apply non-codebook-based precoding for antenna ports associated with subset of resources outside of the maximum coherency validity time. Otherwise, the terminal device 120 may apply full coherency for antenna ports associated with another subset of UL SRS resources configured within the maximum coherency validity time, for non-codebook-based precoding.

In some embodiments, the terminal device 120 may be configured with multiple UL SRS resources for antenna switching. The set of one or more antenna ports associated with the multiple UL SRS resources may correspond to one or more OFDM symbols. In some embodiments, the terminal device 120 may determine the plurality of UL SRS resources from one or more UL SRS resource sets configured for antenna switching. For example, the terminal device 120 may be configured with one or more UL SRS resource sets for antenna switching and the configuration 304 may comprise multiple UL SRS resources associated with multiple SRS resource indicators in the one or more UL SRS resource sets. In some embodiments, the set of one or more antenna ports may comprise at least one antenna port group for simultaneous transmission. Each antenna port group may be associated with a UL SRS resource among the plurality of UL SRS resources. In some embodiments, each UL SRS resource among the one or more UL SRS resources may correspond to a different OFDM symbol among the one or more OFDM symbols. In other words, transmissions using different resources associated with different sets of one or more antenna ports may be performed on different OFDM symbols.

In some embodiments, the terminal device 120 may transmitting the simultaneous SRS transmission with the set of one or more antenna ports over the one or more OFDM symbols with no guard period in-between. Alternatively, there may be a guard period between SRS transmissions with the set of one or more antenna ports over multiple OFDM symbols. Throughout the disclosure, a guard period refers to a period during which the terminal device shall not transmit any RS/signal/channel. In other words, there is scheduling restriction for the UE during the guard period. Throughout the disclosure, the terms “guard period”, “gap period” and “gap” may be used interchangeably.

In some embodiments, the one or more OFDM symbols may be consecutive with no guard period in-between. Alternatively, the one or more OFDM symbols are non-consecutive with usable OFDM symbols for data transmission between the one or more OFDM symbols.

Through the process flow 300, a multi-symbol UL SRS resource configuration where different antenna ports may be distributed over multiple OFDM symbols is supported. By enabling support for the multi-symbol UL SRS resource configuration, UL TX power boosting enhancement can be obtained with respect to UL SRS resource configuration where all TX antenna ports are used simultaneously for transmission within single OFDM symbol. In some embodiments, by enabling support for the multi-symbol-UL SRS resource configuration without any gap restriction, enhanced scheduling flexibility can be obtained.

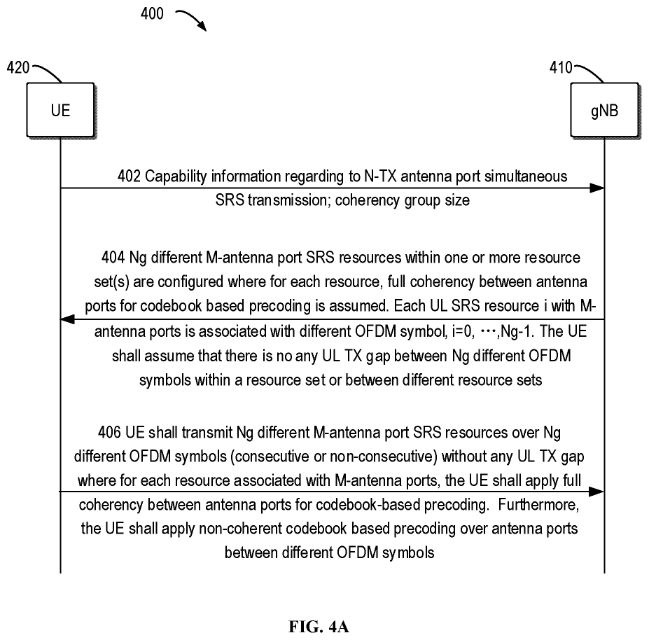

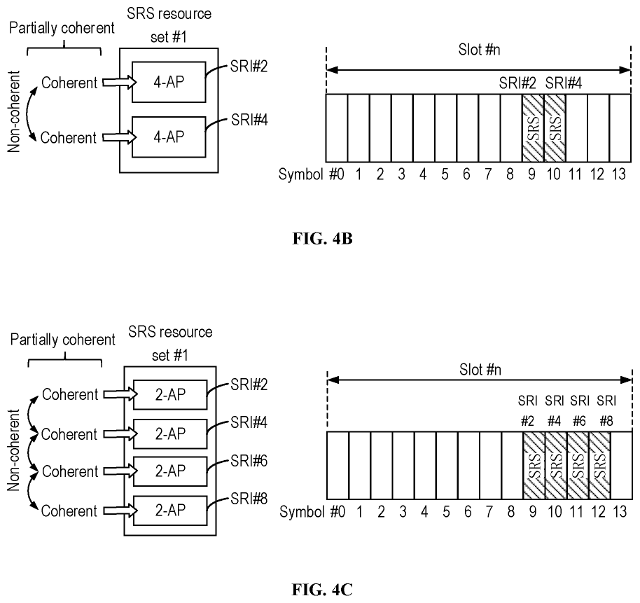

FIG. 4A illustrates an example of a process flow 400 for UL SRS resource configuration and transmission for codebook in accordance with some example embodiments of the present disclosure. For ease of understanding, the process flow 400 will be described with reference to FIG. 1. It would be appreciated that although the process flow 400 has been described referring to the network environment 100 of FIG. 1, this process flow 400 may be likewise applied to other similar communication scenarios. It is noted that the process flow 400 can be considered as an example embodiment of the communication process 300 as discussed hereinbefore. Thus, the UE 420 may be an example of the terminal device 120 in FIG. 1, and the gNB 410 can be considered as an example of the network device 110 in FIG. 1.

As illustrated in FIG. 4A, at 402, the terminal device (denoted as “UE”) 420 may transmit a UE capability report to the network device (denoted as “gNB”) 410. The UE capability report may comprise capability information regarding to N-TX antenna port simultaneous SRS transmission (e.g., N=8). The UE capability report may further comprise antenna port group coherency information. The antenna port group coherency information may comprise coherency group size, i.e., the number of coherent antenna ports per group. The number of coherent antenna ports per group may be assumed to be M=N/Ng, where N is the number of TX antenna port at the UE 420 and Ng is the number of antenna port coherency groups associated with UL SRS resource usage for codebook. Alternatively of additionally, the antenna port group coherency information may comprise the number of antenna port coherency groups associated with UL SRS resource usage for codebook, i.e., N.

At 404, the UE 420 may be configured with a UL SRS resource configuration for simultaneous UL SRS transmission with N-TX antenna ports with one or more UL SRS resource sets with usage for codebook. Different antenna ports associated with different SRS resources may be configured into different OFDM symbols within one or more slots. When the UE 420 is configured with one or more UL SRS resource sets with usage for codebook, Ng different M-antenna port SRS resources may configured within one or more resource set(s) where for each M-antenna port SRS resource full coherency between antenna ports for codebook-based precoding may be assumed. Each UL SRS resource i associated with M antenna ports may be associated with a different OFDM symbol, i=0, . . . , Ng−1. In some embodiment, the UE 420 shall assume that there is no any UL TX gap/guard period between Ng different OFDM symbols within a resource set or between different resource sets. Alternatively, the UE 420 shall assume that there is a UL TX gap/guard period between Ng different OFDM symbols within a resource set or between different resource sets.

At 406, an UL SRS transmission procedure for UL SRS resource set(s) with usage for codebook may be performed where different antenna ports may be configured into different OFDM symbols. When the UE 420 is configured with one or more UL SRS resource sets with usage for codebook, the UE 420 may transmit Ng different M-antenna port SRS resources over Ng different OFDM symbols (either consecutive or non-consecutive) without any TX gap. For each resource associated with M antenna ports, the UE 420 may apply full coherency between antenna ports for codebook-based precoding. In some embodiments, the UE 420 may apply non-coherent codebook-based precoding over antenna ports between different OFDM symbols.

Through the process flow 400, UL SRS resource configuration and transmission procedure for codebook with N UL TX simultaneous antenna ports may be supported, where different antenna ports may be configured over multiple OFDM symbols.

FIG. 4B illustrates a schematic diagram of an exemplary UL SRS resource configuration for codebook in FIG. 4A. As shown in FIG. 4B, the number N of TX antenna port at the UE 420 is 8, the number M of coherent antenna ports per group is 4, and the number Ng of antenna port coherency groups associated with UL SRS resource usage for codebook is 2. In other words, the UE 420 may be configured with UL SRS resources SRI #2 and SRI #4 in SRS resource set #1 configured for codebook. Although SRI #2 and SRI #4 are included in the same SRS resource set, it is only shown for illustration purpose, without any limiting intention. In some embodiments, SRI #2 and SRI #4 may be included in different SRS resource sets configured for codebook. The first group of four antenna ports may be associated with SRI #2 and the second group of four antenna ports may be associated with SRI #4. The four antenna ports in the first group are coherent with each other and the four antenna ports in the second group are coherent with each other. In some embodiments, antenna ports in the first group and antenna ports in the second group may be non-coherent with each other. Alternatively, (some) antenna ports in the first group and antenna ports in the second group may be coherent with each other. Based on the configuration information from the gNB 410, the UL SRS resources SRI #2 and SRI #4 may correspond to OFDM symbols #9 and #10 in slot #n respectively. In other words, the UE 420 may transmit an UL SRS using UL SRS resource SRI #2 with the first group of four antenna ports on OFDM symbol #9 and transmit an UL SRS using UL SRS resource SRI #4 with the second group of four antenna ports on OFDM symbol #10. The UE 420 may apply full coherency between four antenna ports within the first antenna port coherency group for codebook-based precoding. The UE 420 may apply full coherency between four antenna ports within the second antenna port coherency group for codebook-based precoding. In some embodiments, the UL SRS resources SRI #2 and SRI #4 may correspond to two non-consecutive symbols in the same slot or in different slots. In some embodiments, there may be guard period between the non-consecutive symbols corresponding to the UL SRS resources SRI #2 and SRI #4. Alternatively, there may be no scheduling restriction on symbols between the non-consecutive symbols corresponding to the UL SRS resources. In other words, the UE 420 may transmit or receive data, control signals or reference signals from or to the gNB 410 on symbols between the non-consecutive symbols corresponding to the UL SRS resources.

FIG. 4C illustrates a schematic diagram of an exemplary UL SRS resource configuration for codebook in FIG. 4A. As shown in FIG. 4C, the UE 420 may be configured with UL SRS resources SRI #2, SRI #4, SRI #6 and SRI #8 in SRS resource set #1 configured for codebook. Although SRI #2, SRI #4, SRI #6 and SRI #8 are included in the same SRS resource set, it is only shown for illustration purpose, without any limiting intention. In some embodiments, SRI #2, SRI #4, SRI #6 and SRI #8 may be included in different SRS resource sets configured for codebook. The first, second, third and fourth groups of two antenna ports may be associated with SRI #2, SRI #4, SRI #6 and SRI #8, respectively. The two antenna ports in each group are coherent with each other. In some embodiments, antenna ports from different groups may be non-coherent with each other. Alternatively, (some) antenna ports from different groups may be coherent with each other. Based on the configuration information from the gNB 410, the UL SRS resources SRI #2, SRI #4, SRI #6 and SRI #8 may correspond to OFDM symbols #9 to #12 in slot #n respectively. In other words, the UE 420 may transmit an UL SRS using UL SRS resource SRI #2 with the first group of two antenna ports on OFDM symbol #9, transmit an UL SRS using UL SRS resource SRI #4 with the second group of two antenna ports on OFDM symbol #10, transmit an UL SRS using UL SRS resource SRI #6 with the third group of two antenna ports on OFDM symbol #11 and transmit an UL SRS using UL SRS resource SRI #8 with the fourth group of two antenna ports on OFDM symbol #12. The UE 420 may apply full coherency between two antenna ports within the same antenna port coherency group for codebook-based precoding. In some embodiments, the UL SRS resources SRI #2, SRI #4, SRI #6 and SRI #8 may correspond to four non-consecutive symbols in the same slot or in different slots. In some embodiments, there may be guard period between the non-consecutive symbols corresponding to the UL SRS resources SRI #2, SRI #4, SRI #6 and SRI #8. Alternatively, there may be no scheduling restriction on symbols between the non-consecutive symbols corresponding to the UL SRS resources. In other words, the UE 420 may transmit or receive data, control signals or reference signals from or to the gNB 410 on symbols between the non-consecutive symbols corresponding to the UL SRS resources.

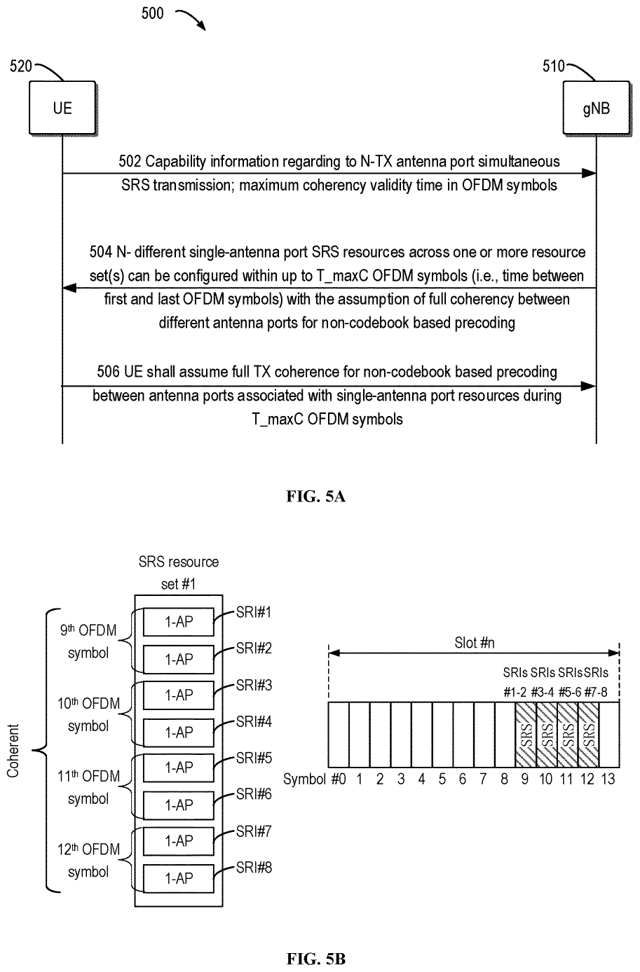

FIG. 5A illustrates an example of a process flow 500 for UL SRS resource configuration and transmission for non-codebook in accordance with some example embodiments of the present disclosure. For ease of understanding, the process flow 500 will be described with reference to FIG. 1. It would be appreciated that although the process flow 500 has been described referring to the network environment 100 of FIG. 1, this process flow 500 may be likewise applied to other similar communication scenarios. It is noted that the process flow 500 can be considered as an example embodiment of the communication process 300 as discussed hereinbefore. Thus, the UE 520 may be an example of the terminal device 120 in FIG. 1, and the gNB 510 can be considered as an example of the network device 110 in FIG. 1.

As illustrated in FIG. 5A, at 502, the terminal device (denoted as “UE”) 520 may transmit a UE capability report to the network device (denoted as “gNB”) 510. The UE capability report may comprise capability information regarding to N-TX antenna port simultaneous SRS transmission (e.g., N=8). The UE capability report may further comprise maximum coherency validity time in OFDM symbols. The maximum coherency validity time may be the time between the first and last OFDM symbols associated with corresponding single-antenna port resources with the assumption of full coherency between antenna ports. The maximum coherency validity time may be may be represented as T_maxC, subject to numerology. The maximum coherency validity time may be associated with UL SRS resource usage for non-codebook.

At 504, the UE 520 may be configured with a UL SRS resource configuration for simultaneous UL SRS transmission with N-TX antenna ports with one or more UL SRS resource sets with usage for non-codebook. Different antenna ports associated with different SRS resources may be configured into different OFDM symbols within one or more slots. When the UE 520 is configured with one or more UL SRS resource sets with usage for non-codebook, N different single-antenna port resources may be configured within one or more resource set(s).

N different single-antenna port SRS resources across one or more resource set(s) may be configured within up to T_maxC OFDM symbols (i.e. time between first and last OFDM symbol) with the assumption of full coherency between different antenna ports for non-codebook based precoding. For example, the UE 520 with simultaneous N=8 antenna ports may be provided in the capability report T_maxC=3. The UE 520 may be configured with one or more resource sets with usage for non-codebook. Based on the configuration from gNB 510, the UE 520 may be configured with 8 different single-antenna port resources within the one or more resource sets. A first group of four antenna ports may be associated with a first group of four single antenna port SRS resources, and a second group of four antenna ports may be associated with a second group of four single antenna port SRS resources. The first group of four single antenna port SRS resources may correspond to one OFDM symbol and the second group of four single antenna port SRS resources SRS resources may correspond to another OFDM symbol. For example, the OFDM symbol corresponding to the first group of four single antenna port SRS resources may be a 5th OFDM symbol and the OFDM symbol corresponding to the second group of four single antenna port SRS resources may be the 6th OFDM symbol or the 7th OFDM symbol or the 8th OFDM symbol. In other words, the OFDM symbols may be within the maximum coherency validity time, i.e., T_maxC OFDM symbols and may be possibly consecutive or non-consecutive symbols.

If the number of OFDM symbols configured with single-antenna port resources is less than the T_maxC, there may be no scheduling restriction for the network to schedule any UL reference signals/channels (i.e. data or control signal or reference signal) by using any of N-TX antenna ports for remaining symbols within the maximum coherency validity time.

At 506, an UL SRS transmission procedure for UL SRS resource set(s) with usage for non-codebook may be performed where different antenna ports may be configured into different OFDM symbols. When the UE 520 is configured with one or more UL SRS resource sets with usage for non-codebook, the UE 520 may assume full TX coherence for non-codebook based precoding between antenna ports associated with single-antenna port resources during T_maxC OFDM symbols. If the number of configured OFDM symbols exceeds T_maxC, the UE 520 may only apply full TX coherency for a sub-set of one or more antenna ports, among the N antenna ports, which are configured within the maximum coherency validity time, for non-codebook based precoding.

Through the process flow 500, UL SRS resource configuration and transmission procedure for non-codebook with N UL TX simultaneous antenna ports may be supported, where different antenna ports may be configured over multiple OFDM symbols.

FIG. 5B illustrates a schematic diagram of an exemplary UL SRS resource configuration for non-codebook in FIG. 5A. As shown in FIG. 5B, the UE 520 may be configured with UL SRS resources SRI #1 to SRI #8 in SRS resource set #1 configured for non-codebook. Although UL SRS resources SRI #1 to SRI #8 are included in the same SRS resource set, it is only shown for illustration purpose, without any limiting intention. In some embodiments, UL SRS resources SRI #1 to SRI #8 may be included in different SRS resource sets configured for non-codebook. Different antenna port of the eight antenna port of the UE 520 may be associated with different UL SRS resources among the UL SRS resources SRI #1 to SRI #8. In other words, each of the UL SRS resources SRI #1 to SRI #8 is associated with a single antenna port. The UL SRS resources SRI #1 to SRI #8 may be referred to as single-antenna port resources. Based on the configuration information from the gNB 510, the single-antenna port resources SRI #1 to SRI #8 may correspond to OFDM symbols #9 to #12 in slot #n respectively, as shown in FIG. 5B. When the maximum coherency validity time is no less than four OFDM symbols, the eight antenna ports are coherent with each other and the UE 520 may apply full coherency for the eight antenna ports for non-codebook-based precoding.

In some embodiments, if the maximum coherency validity time is less than four OFDM symbols, i.e., three OFDM symbols, a subset of six antenna ports among the eight antenna ports, e.g., antenna ports associated with single-antenna port resources SRI #1 to SRI #6 corresponding to OFDM symbols #9 to #11, are coherent with each other and the UE 520 may apply full coherency for the six antenna ports for non-codebook-based precoding. The remaining two antenna ports associated with single-antenna port resources SRI #7 to SRI #8 corresponding to OFDM symbol #12, are non-coherent with the six antenna ports and the UE 520 may not apply full coherency for the six antenna ports for non-codebook-based precoding. In some embodiments, the single-antenna port resources SRI #1 to SRI #6 may correspond to non-consecutive symbols in the same slot or in different slots.

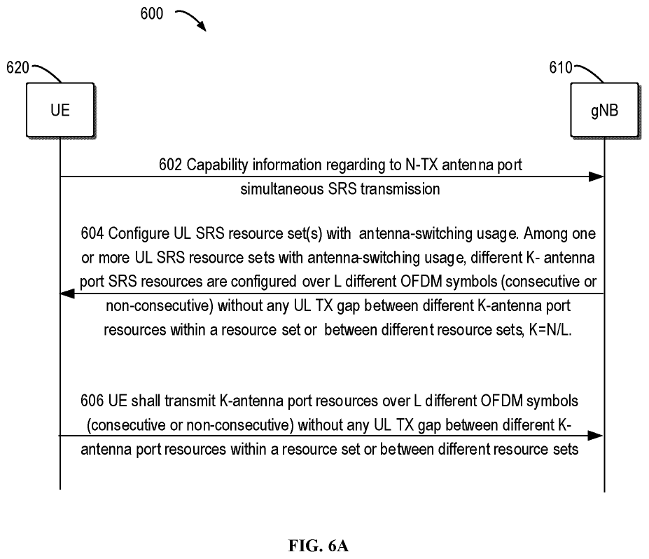

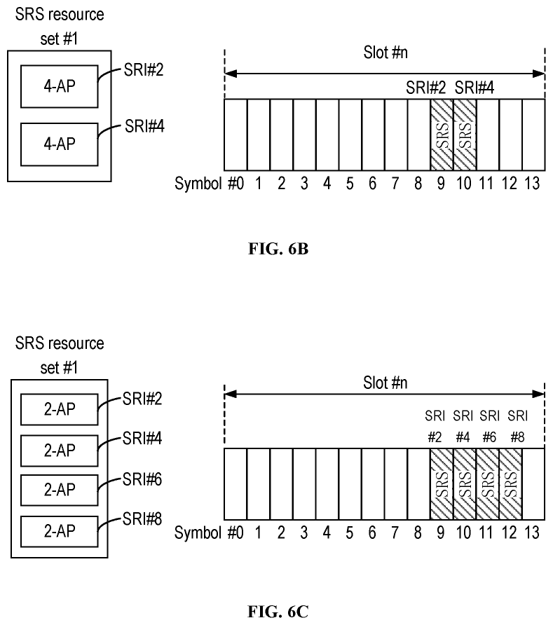

FIG. 6A illustrates an example of a process flow 600 for UL SRS resource configuration and transmission for antenna switching in accordance with some example embodiments of the present disclosure. For ease of understanding, the process flow 600 will be described with reference to FIG. 1. It would be appreciated that although the process flow 600 has been described referring to the network environment 100 of FIG. 1, this process flow 600 may be likewise applied to other similar communication scenarios. It is noted that the process flow 600 can be considered as an example embodiment of the communication process 300 as discussed hereinbefore. Thus, the UE 620 may be an example of the terminal device 120 in FIG. 1, and the gNB 610 can be considered as an example of the network device 110 in FIG. 1.

As illustrated in FIG. 6A, at 602, the terminal device (denoted as “UE”) 620 may transmit a UE capability report to the network device (denoted as “gNB”) 610. The UE capability report may comprise capability information regarding to N-TX antenna port simultaneous SRS transmission (e.g., N=8).

At 604, the UE 620 may be configured with a UL SRS resource configuration for simultaneous UL SRS transmission with N-TX antenna ports with one or more UL SRS resource sets with usage for antenna switching. Different antenna ports associated with different SRS resources may be configured into different OFDM symbols within one or more slots.

In some embodiments, when the UE 620 is configured with one or more UL SRS resource sets with usage for antenna switching with xTyR where x=y, L different K-antenna port SRS resources within one or more resource set(s) may be configured over L different OFDM symbols (consecutive or non-consecutive) without any UL TX gap between L different K-antenna port resources within a resource set or between different resource sets, where K=N/L.

In some embodiments, when the UE 620 is configured with one or more UL SRS resource sets with usage for antenna switching with xTyR where xy, e.g. x=1,2,4 and y=1,2,4,6,8, UE may be configured with Q different UL SRS resources. Each X-antenna port UL SRS resource may be further sub-divided into Q′ different UL SRS sub-resources with X′-antenna ports (X′<X) in each sub-resource, such that Q′=X/X′ is an integer number. Q′ different X′-antenna port resources may be configured within one or multiple resource sets associated with multiple OFDM symbols. In some embodiments, the UE 620 may not assume that there is no guard period/gap between Q′-different resources, which holds only for sub-divided X′-antenna port resources. In some embodiments, when Q multiple X-antenna port UL SRS resources are divided into Nq sub-resource groups, the UE 620 may assume that there is guard period/gap between SRS resources associated with different Nq resource group with multiple X′-antenna port resources.

For example, the UE 620 may be configured with 2T4R antenna switching, with Q=2 different resources with X=2-antenna ports within one resource set. After sub-division, Q′=2 different SRS sub-resources with X′=1 antenna port in each sub-resource (Q′=X/X′=2/1). Overall, new resource configuration has Nq=2 sub-resource groups, where antenna ports belonging into a first sub-resource group do not have guard period/gap between resources within the first sub-resource group. Similar applies also to different antenna ports associated the second sub-resource group. However, the UE 620 may assume that there is guard period/gap between antenna ports associated with corresponding resources between different sub-groups.

At 606, an UL SRS transmission procedure for UL SRS resource set(s) with usage for antenna switching may be performed where different antenna ports may be configured into different OFDM symbols. When the UE 620 is configured with one or more UL SRS resource sets with usage for antenna switching with simultaneous N-TX antenna port capability, the UE 620 may transmit K-antenna port resources over L different OFDM symbols (consecutive or non-consecutive) without any UL TX gap between different K-antenna port resources within a resource set or between different resource sets Through the process flow 600, UL SRS resource configuration and transmission procedure for antenna switching with N UL TX simultaneous antenna ports may be supported, where different antenna ports may be configured over multiple OFDM symbols.

FIG. 6B illustrates a schematic diagram of an exemplary UL SRS resource configuration for antenna switching in FIG. 6A. As shown in FIG. 6B, the UE 620 may be configured with UL SRS resources SRI #2 and SRI #4 in SRS resource set #1 configured for antenna switching. Although SRI #2 and SRI #4 are included in the same SRS resource set, it is only shown for illustration purpose, without any limiting intention. In some embodiments, SRI #2 and SRI #4 may be included in different SRS resource sets configured for antenna switching. The first group of four antenna ports may be associated with SRI #2 and the second group of four antenna ports may be associated with SRI #4. Based on the configuration information from the gNB 610, the UL SRS resources SRI #2 and SRI #4 may correspond to OFDM symbols #9 and #10 in slot #n respectively. In some embodiments, the UL SRS resources SRI #2 and SRI #4 may correspond to two non-consecutive symbols in the same slot or in different slots.

FIG. 6C illustrates a schematic diagram of another exemplary UL SRS resource configuration for antenna switching in FIG. 6A. As shown in FIG. 6C, the UE 620 may be configured with UL SRS resources SRI #2, SRI #4, SRI #6 and SRI #8 in SRS resource set #1 configured for antenna switching. Although SRI #2, SRI #4, SRI #6 and SRI #8 are included in the same SRS resource set, it is only shown for illustration purpose, without any limiting intention. In some embodiments, SRI #2, SRI #4, SRI #6 and SRI #8 may be included in different SRS resource sets configured for antenna switching. The first, second, third and fourth groups of two antenna ports may be associated with SRI #2, SRI #4, SRI #6 and SRI #8, respectively. Based on the configuration information from the gNB 610, the UL SRS resources SRI #2, SRI #4, SRI #6 and SRI #8 may correspond to OFDM symbols #9 to #12 in slot #n respectively. In some embodiments, the UL SRS resources SRI #2, SRI #4, SRI #6 and SRI #8 may correspond to non-consecutive symbols in the same slot or in different slots.

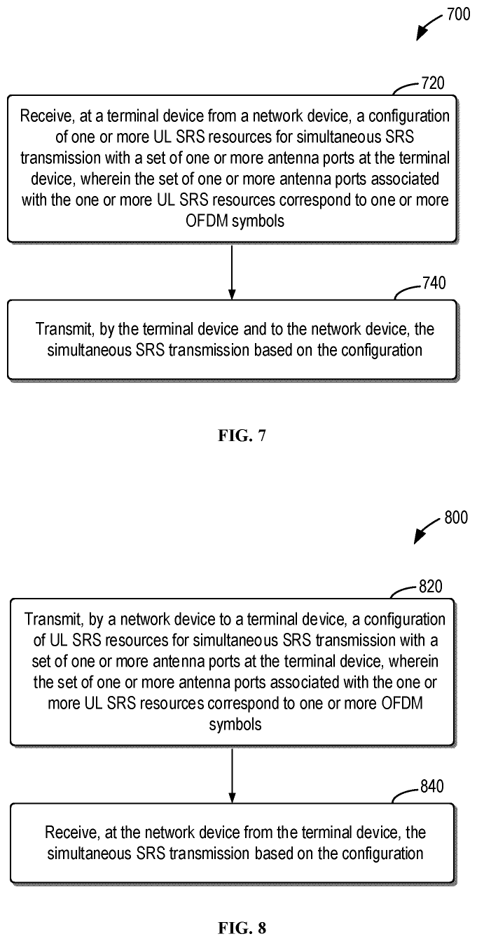

FIG. 7 illustrates a flowchart of an example method 700 implemented at a terminal device in accordance with some other embodiments of the present disclosure. For ease of understanding, the method 700 will be described from the perspective of the terminal device 120 with reference to FIG. 1.

At block 720, the terminal device 120 receives, from a network device 110, a configuration of one or more uplink (UL) sounding reference signal (SRS) resources for simultaneous SRS transmission with a set of one or more antenna ports at the terminal device 120. The set of one or more antenna ports associated with the one or more UL SRS resources correspond to one or more orthogonal frequency division multiplexing (OFDM) symbols. At block 740, the terminal device 120 transmits, to the network device 110, the simultaneous SRS transmission based on the configuration.

In some example embodiments, each UL SRS resource among the one or more UL SRS resources may correspond to a different OFDM symbol among the one or more OFDM symbols.

In some example embodiments, the set of one or more antenna ports may comprise at least one antenna port coherency group, wherein each antenna port coherency group is associated with a UL SRS resource among the one or more UL SRS resources. In some example embodiments, the terminal device 120 may apply full coherency between antenna ports within the same antenna port coherency group for codebook-based precoding. In some example embodiments, the terminal device 120 may apply non-coherency between antenna ports within different antenna port coherency groups for codebook-based precoding.

In some example embodiments, the terminal device 120 may transmit antenna port group coherency information to the network device 110. The antenna port group coherency information may comprise a number of antenna port coherency groups. Alternatively or additionally, the antenna port group coherency information may comprise a number of antenna ports per antenna port coherency group.

In some example embodiments, the one or more UL SRS resources may comprise a plurality of UL SRS resources comprising at least one UL SRS resource group. The one or more OFDM symbols may comprise a plurality of OFDM symbols. Each UL SRS resource group among the at least one UL SRS resource group may correspond to a different OFDM symbol among the plurality of OFDM symbols.

In some example embodiments, each UL SRS resource among the plurality of UL SRS resources may be associated with a single antenna port among the set of one or more antenna ports. In some example embodiments, the terminal device 120 may apply full coherency between antenna ports within the set of one or more antenna ports for non-codebook-based precoding.

In some example embodiments, the terminal device 120 may transmit antenna port group coherency information to the network device 110. The antenna port group coherency information may at least comprise a maximum coherency validity time in unit of OFDM symbols. The maximum coherency validity time may be a time period between a first OFDM symbol and a last OFDM symbol corresponding to UL SRS resources associated with antenna ports with full coherency in-between.

In some example embodiments, a number of UL SRS resource groups may be less than a number of OFDM symbols in the maximum coherency validity time. Remaining OFDM symbols in the maximum coherency validity time except for OFDM symbols corresponding to the at least one UL SRS resource group may be available for transmission of uplink or downlink information. The uplink or downlink information may be associated with data signals. Alternatively or additionally, the uplink or downlink information may be associated with control signals. Alternatively or additionally, the uplink or downlink information may be associated with reference signals.

In some example embodiments, a subset of UL SRS resources may be configured with transmission occasions that outside of a number of OFDM symbols in the maximum coherency validity time. The terminal device 120 may not to apply non-codebook based precoding for antenna ports associated with subset of resources being outside of the maximum coherency validity time. Otherwise, the terminal device 120 may apply full coherency for antenna ports associated with another subset of resources for non-codebook-based precoding, wherein the another subset of resources are configured within the maximum coherency validity time.

In some example embodiments, the one or more UL SRS resources may comprise a plurality of UL SRS resources. The terminal device 120 may determine the plurality of UL SRS resources from one or more UL SRS resource sets configured for antenna switching. The set of one or more antenna ports may comprise at least one antenna port group. Each antenna port group may be associated with a UL SRS resource among the plurality of UL SRS resources.

In some example embodiments, when transmitting the simultaneous SRS transmission, the terminal device 120 may transmit the simultaneous SRS transmission with the set of one or more antenna ports over the one or more OFDM symbols with no guard period in-between.

In some example embodiments, the one or more OFDM symbols may be consecutive with no guard period in-between. Alternatively, the one or more OFDM symbols may be non-consecutive with usable OFDM symbols for data transmission between the one or more OFDM symbols.

In some example embodiments, the terminal device 120 may transmit, to the network device 110, capability information related to the simultaneous SRS transmission on the set of one or more antenna ports at the terminal device 120.

FIG. 8 illustrates another flowchart of an example method 800 implemented at a network device 110 in accordance with some other embodiments of the present disclosure. For ease of understanding, the method 800 will be described from the perspective of the network device 110 with reference to FIG. 1.

At block 820, the network device 110 transmits, to the terminal device 120, a configuration of one or more uplink (UL) sounding reference signal (SRS) resources for simultaneous SRS transmission with a set of one or more antenna ports at the terminal device 120. The set of one or more antenna ports associated with the one or more UL SRS resources correspond to one or more orthogonal frequency division multiplexing (OFDM) symbols. At block 820, the network device 110 receives the simultaneous SRS transmission from the terminal device 120 based on the configuration.

In some example embodiments, each UL SRS resource among the one or more UL SRS resources may correspond to a different OFDM symbol among the one or more OFDM symbols. In some example embodiments, the set of one or more antenna ports may comprise at least one antenna port coherency group, wherein each antenna port coherency group is associated with a UL SRS resource among the one or more UL SRS resources.

In some example embodiments, the network device 110 may receive antenna port group coherency information from the terminal device 120 and determine the configuration at least based on the antenna port group coherency information. The antenna port group coherency information may comprise a number of antenna port coherency groups. Alternatively or additionally, the antenna port group coherency information may comprise a number of antenna ports per antenna port coherency group.

In some example embodiments, the one or more UL SRS resources may comprise a plurality of UL SRS resources comprising at least one UL SRS resource group. The one or more OFDM symbols may comprise a plurality of OFDM symbols. Each UL SRS resource group among the at least one UL SRS resource group may correspond to a different OFDM symbol among the plurality of OFDM symbols. In some example embodiments, each UL SRS resource among the plurality of UL SRS resources may be associated with a single antenna port among the set of one or more antenna ports.

In some example embodiments, the network device 110 may receive antenna port group coherency information from the terminal device 120 and determine the configuration at least based on the antenna port group coherency information. The antenna port group coherency information may at least comprise a maximum coherency validity time in unit of OFDM symbols. The maximum coherency validity time may be a time period between a first OFDM symbol and a last OFDM symbol corresponding to UL SRS resources associated with antenna ports with full coherency in-between.

In some example embodiments, a number of UL SRS resource groups may be less than a number of OFDM symbols in the maximum coherency validity time. Remaining OFDM symbols in the maximum coherency validity time except for OFDM symbols corresponding to the at least one UL SRS resource group may be available for transmission of uplink or downlink information. The uplink or downlink information may be associated with data signals. Alternatively or additionally, the uplink or downlink information may be associated with control signals. Alternatively or additionally, the uplink or downlink information may be associated with reference signals.

In some example embodiments, the one or more UL SRS resources may comprise a plurality of UL SRS resources. The network device 110 may determine the plurality of UL SRS resources from one or more UL SRS resource sets configured for antenna switching. The set of one or more antenna ports may comprise at least one antenna port group. Each antenna port group may be associated with a UL SRS resource among the plurality of UL SRS resources.

In some example embodiments, when receiving the simultaneous SRS transmission, the network device 110 may receive the simultaneous SRS transmission with the set of one or more antenna ports over the one or more OFDM symbols with no guard period in-between.

In some example embodiments, the one or more OFDM symbols may be consecutive with no guard period in-between. Alternatively, the one or more OFDM symbols may be non-consecutive with usable OFDM symbols for data transmission between the one or more OFDM symbols.

In some example embodiments, the network device 110 may receive, from the terminal device 120, capability information related to the simultaneous SRS transmission on the set of one or more antenna ports at the terminal device 120.

In some embodiments, an apparatus capable of performing the method 700 (for example, the terminal device 120) may comprise means for performing the respective steps of the method 700. The means may be implemented in any suitable form. For example, the means may be implemented in a circuitry or software module.

In some example embodiments, the apparatus comprises: means for receiving, from a network device, a configuration of one or more uplink (UL) sounding reference signal (SRS) resources for simultaneous SRS transmission with a set of one or more antenna ports at the apparatus, wherein the set of one or more antenna ports associated with the one or more UL SRS resources correspond to one or more orthogonal frequency division multiplexing (OFDM) symbols; and means for transmitting, to the network device, the simultaneous SRS transmission based on the configuration.

In some example embodiments, each UL SRS resource among the one or more UL SRS resources may correspond to a different OFDM symbol among the one or more OFDM symbols.

In some example embodiments, the set of one or more antenna ports may comprise at least one antenna port coherency group, wherein each antenna port coherency group is associated with a UL SRS resource among the one or more UL SRS resources. In some example embodiments, the apparatus may further comprise means for applying full coherency between antenna ports within the same antenna port coherency group for codebook-based precoding. In some example embodiments, the apparatus may further comprise means for applying non-coherency between antenna ports within different antenna port coherency groups for codebook-based precoding.

In some example embodiments, the apparatus may further comprise means for transmitting antenna port group coherency information to the network device. The antenna port group coherency information may comprise a number of antenna port coherency groups. Alternatively or additionally, the antenna port group coherency information may comprise a number of antenna ports per antenna port coherency group.

In some example embodiments, the one or more UL SRS resources may comprise a plurality of UL SRS resources comprising at least one UL SRS resource group. The one or more OFDM symbols may comprise a plurality of OFDM symbols. Each UL SRS resource group among the at least one UL SRS resource group may correspond to a different OFDM symbol among the plurality of OFDM symbols.

In some example embodiments, each UL SRS resource among the plurality of UL SRS resources may be associated with a single antenna port among the set of one or more antenna ports. In some example embodiments, the apparatus may further comprise means for applying full coherency between antenna ports within the set of one or more antenna ports for non-codebook-based precoding.

In some example embodiments, the apparatus may further comprise means for transmitting antenna port group coherency information to the network device. The antenna port group coherency information may at least comprise a maximum coherency validity time in unit of OFDM symbols. The maximum coherency validity time may be a time period between a first OFDM symbol and a last OFDM symbol corresponding to UL SRS resources associated with antenna ports with full coherency in-between.

In some example embodiments, a number of UL SRS resource groups may be less than a number of OFDM symbols in the maximum coherency validity time. Remaining OFDM symbols in the maximum coherency validity time except for OFDM symbols corresponding to the at least one UL SRS resource group may be available for transmission of uplink or downlink information. The uplink or downlink information may be associated with data signals. Alternatively or additionally, the uplink or downlink information may be associated with control signals. Alternatively or additionally, the uplink or downlink information may be associated with reference signals.

In some example embodiments, a subset of UL SRS resources may be configured with transmission occasions that outside of a number of OFDM symbols in the maximum coherency validity time. The apparatus may further comprise means for not applying non-codebook based precoding for antenna ports associated with subset of resources being outside of the maximum coherency validity time. Otherwise, the apparatus may further comprise means for applying full coherency for antenna ports associated with another subset of resources for non-codebook-based precoding, wherein the another subset of resources are configured within the maximum coherency validity time.

In some example embodiments, the one or more UL SRS resources may comprise a plurality of UL SRS resources. The apparatus may further comprise means for determining the plurality of UL SRS resources from one or more UL SRS resource sets configured for antenna switching. The set of one or more antenna ports may comprise at least one antenna port group. Each antenna port group may be associated with a UL SRS resource among the plurality of UL SRS resources.

In some example embodiments, when transmitting the simultaneous SRS transmission, the apparatus may further comprise means for transmitting the simultaneous SRS transmission with the set of one or more antenna ports over the one or more OFDM symbols with no guard period in-between.

In some example embodiments, the one or more OFDM symbols may be consecutive with no guard period in-between. Alternatively, the one or more OFDM symbols may be non-consecutive with usable OFDM symbols for data transmission between the one or more OFDM symbols.

In some example embodiments, the apparatus may further comprise means for transmitting, to the network device, capability information related to the simultaneous SRS transmission on the set of one or more antenna ports at the terminal device.

In some embodiments, the apparatus further comprises means for performing other steps in some embodiments of the method 700. In some embodiments, the means comprises at least one processor and at least one memory including computer program code, the at least one memory and computer program code configured to, with the at least one processor, cause the performance of the apparatus.

In some embodiments, an apparatus capable of performing the method 800 (for example, the network device 110) may comprise means for performing the respective steps of the method 800. The means may be implemented in any suitable form. For example, the means may be implemented in a circuitry or software module.

In some example embodiments, the apparatus comprises: means for transmitting, by a network device and to a terminal device, a configuration of one or more uplink (UL) sounding reference signal (SRS) resources for simultaneous SRS transmission with a set of one or more antenna ports at the terminal device, wherein the set of one or more antenna ports associated with the one or more UL SRS resources correspond to one or more orthogonal frequency division multiplexing (OFDM) symbols; and means for receiving, at the network device and from the terminal device, the simultaneous SRS transmission based on the configuration.

In some example embodiments, each UL SRS resource among the one or more UL SRS resources may correspond to a different OFDM symbol among the one or more OFDM symbols. In some example embodiments, the set of one or more antenna ports may comprise at least one antenna port coherency group, wherein each antenna port coherency group is associated with a UL SRS resource among the one or more UL SRS resources.

In some example embodiments, the apparatus may further comprise means for receiving antenna port group coherency information from the terminal device and means for determining the configuration at least based on the antenna port group coherency information. The antenna port group coherency information may comprise a number of antenna port coherency groups. Alternatively or additionally, the antenna port group coherency information may comprise a number of antenna ports per antenna port coherency group.

In some example embodiments, the one or more UL SRS resources may comprise a plurality of UL SRS resources comprising at least one UL SRS resource group. The one or more OFDM symbols may comprise a plurality of OFDM symbols. Each UL SRS resource group among the at least one UL SRS resource group may correspond to a different OFDM symbol among the plurality of OFDM symbols. In some example embodiments, each UL SRS resource among the plurality of UL SRS resources may be associated with a single antenna port among the set of one or more antenna ports.

In some example embodiments, the apparatus may further comprise means for receiving antenna port group coherency information from the terminal device and means for determining the configuration at least based on the antenna port group coherency information. The antenna port group coherency information may at least comprise a maximum coherency validity time in unit of OFDM symbols. The maximum coherency validity time may be a time period between a first OFDM symbol and a last OFDM symbol corresponding to UL SRS resources associated with antenna ports with full coherency in-between.

In some example embodiments, a number of UL SRS resource groups may be less than a number of OFDM symbols in the maximum coherency validity time. Remaining OFDM symbols in the maximum coherency validity time except for OFDM symbols corresponding to the at least one UL SRS resource group may be available for transmission of uplink or downlink information. The uplink or downlink information may be associated with data signals. Alternatively or additionally, the uplink or downlink information may be associated with control signals. Alternatively or additionally, the uplink or downlink information may be associated with reference signals.

In some example embodiments, the one or more UL SRS resources may comprise a plurality of UL SRS resources. The apparatus may further comprise means for determining the plurality of UL SRS resources from one or more UL SRS resource sets configured for antenna switching. The set of one or more antenna ports may comprise at least one antenna port group. Each antenna port group may be associated with a UL SRS resource among the plurality of UL SRS resources.

In some example embodiments, when receiving the simultaneous SRS transmission, the apparatus may further comprise means for receiving the simultaneous SRS transmission with the set of one or more antenna ports over the one or more OFDM symbols with no guard period in-between.

In some example embodiments, the one or more OFDM symbols may be consecutive with no guard period in-between. Alternatively, the one or more OFDM symbols may be non-consecutive with usable OFDM symbols for data transmission between the one or more OFDM symbols.

In some example embodiments, the apparatus may further comprise means for receiving, from the terminal device, capability information related to the simultaneous SRS transmission on the set of one or more antenna ports at the terminal device.

In some embodiments, the apparatus further comprises means for performing other steps in some embodiments of the method 800. In some embodiments, the means comprises at least one processor and at least one memory including computer program code, the at least one memory and computer program code configured to, with the at least one processor, cause the performance of the apparatus.

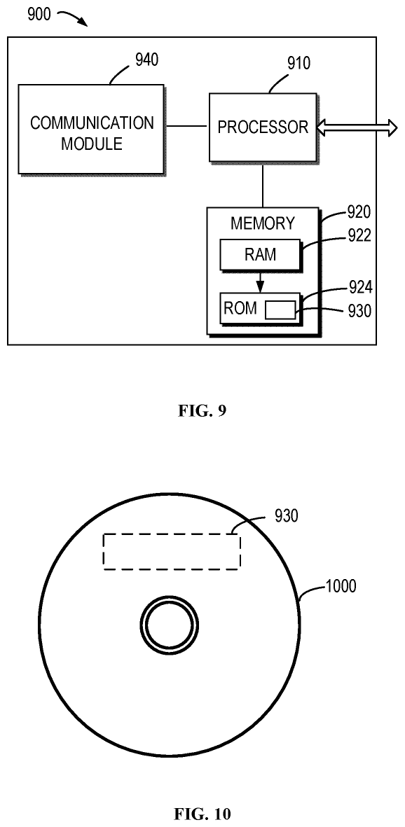

FIG. 9 illustrates a simplified block diagram of a device 900 that is suitable for implementing some example embodiments of the present disclosure. The device 900 may be provided to implement a communication device, for example, the network device 110 or the terminal device 120 as shown in FIG. 1. As shown, the device 900 includes one or more processors 910, one or more memories 920 coupled to the processor 910, and one or more communication modules 940 coupled to the processor 910.

The communication module 940 is for bidirectional communications. The communication module 940 has at least one antenna to facilitate communication. The communication interface may represent any interface that is necessary for communication with other network elements.

The processor 910 may be of any type suitable to the local technical network and may include one or more of the following: general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

The memory 920 may include one or more non-volatile memories and one or more volatile memories. Examples of the non-volatile memories include, but are not limited to, a Read Only Memory (ROM) 924, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 922 and other volatile memories that will not last in the power-down duration.

A computer program 930 includes computer executable instructions that are executed by the associated processor 910. The program 930 may be stored in the ROM 924. The processor 910 may perform any suitable actions and processing by loading the program 930 into the RAM 922.

The embodiments of the present disclosure may be implemented by means of the program 930 so that the device 900 may perform any process of the disclosure as discussed with reference to FIGS. 2 to 3. The embodiments of the present disclosure may also be implemented by hardware or by a combination of software and hardware.

In some example embodiments, the program 930 may be tangibly contained in a computer-readable medium which may be included in the device 900 (such as in the memory 920) or other storage devices that are accessible by the device 900. The device 900 may load the program 930 from the computer-readable medium to the RAM 922 for execution. The computer-readable medium may include any types of tangible non-volatile storage, such as ROM, EPROM, a flash memory, a hard disk, CD, DVD, and the like.

FIG. 10 illustrates a block diagram of an example of a computer-readable medium 1000 in accordance with some example embodiments of the present disclosure. The computer-readable medium 1000 has the program 930 stored thereon. It is noted that although the computer-readable medium 1000 is depicted in form of CD or DVD in FIG. 9, the computer-readable medium 1000 may be in any other form suitable for carry or hold the program 930.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer-readable storage medium. The computer program product includes computer-executable instructions, such as those included in program modules, being executed in a device on a target real or virtual processor, to carry out the method 700 or 800 as described above with reference to FIG. 7 or 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer-readable medium, and the like.

The computer-readable medium may be a computer-readable signal medium or a computer-readable storage medium. A computer-readable medium may include but not limited to an electronic, magnetic, optical, electromagnetic, infrared, or semiconductor system, apparatus, or device, or any suitable combination of the foregoing. More specific examples of the computer-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-34. (canceled)

35. An apparatus comprising:
at least one processor; and
at least one memory storing instructions that, when executed by the at least one processor, cause the apparatus at least to:
receive, from a network device, a configuration of one or more uplink, UL, sounding reference signal, SRS, resources for simultaneous SRS transmission via a set of one or more antenna ports at the apparatus, wherein the set of one or more antenna ports associated with the one or more UL SRS resources correspond to one or more orthogonal frequency division multiplexing, OFDM, symbols; and
transmit, to the network device, the simultaneous SRS transmission based on the configuration.

36. The apparatus of claim 35, wherein each UL SRS resource among the one or more UL SRS resources corresponds to a different OFDM symbol among the one or more OFDM symbols.

37. The apparatus of claim 35, wherein the set of one or more antenna ports comprises at least one antenna port coherency group, wherein each antenna port coherency group is associated with a UL SRS resource among the one or more UL SRS resources.

38. The apparatus of claim 37, wherein the apparatus is further caused to:
apply full coherency between antenna ports within the same antenna port coherency group for codebook-based precoding.

39. The apparatus of claim 37, wherein the apparatus is further caused to:
apply non-coherency between antenna ports within different antenna port coherency groups for codebook-based precoding.

40. The apparatus of claim 37, wherein the apparatus is further caused to:
transmit, to the network device, antenna port group coherency information comprising at least one of:
a number of antenna port coherency groups; or
a number of antenna ports per antenna port coherency group.

41. The apparatus of claim 35, wherein the one or more UL SRS resources comprise a plurality of UL SRS resources comprising at least one UL SRS resource group and the one or more OFDM symbols comprise a plurality of OFDM symbols, wherein each UL SRS resource group among the at least one UL SRS resource group corresponds to a different OFDM symbol among the plurality of OFDM symbols.

42. The apparatus of claim 41, wherein each UL SRS resource among the plurality of UL SRS resources is associated with a single antenna port among the set of one or more antenna ports.

43. The apparatus of claim 41, wherein the apparatus is further caused to:
apply full coherency between antenna ports within the set of one or more antenna ports for non-codebook-based precoding.

44. The apparatus of claim 41, wherein the apparatus is further caused to:
transmit, to the network device, antenna port group coherency information at least comprising a maximum coherency validity time in unit of OFDM symbols,
wherein the maximum coherency validity time is a time period between a first OFDM symbol and a last OFDM symbol corresponding to UL SRS resources associated with antenna ports with full coherency in-between.

45. The apparatus of claim 35, wherein the one or more UL SRS resources comprise a plurality of UL SRS resources, the apparatus is further caused to:
determine the plurality of UL SRS resources from one or more UL SRS resource sets configured for antenna switching,
wherein the set of one or more antenna ports comprises at least one antenna port group, wherein each antenna port group is associated with a UL SRS resource among the plurality of UL SRS resources.

46. The apparatus of claim 35, wherein the apparatus is caused to transmit the simultaneous SRS transmission by:
transmitting the simultaneous SRS transmission with the set of one or more antenna ports over the one or more OFDM symbols with no guard period in-between.

47. The apparatus of claim 35, wherein:
the one or more OFDM symbols are consecutive with no guard period in-between; or
the one or more OFDM symbols are non-consecutive with usable OFDM symbols for data transmission between the one or more OFDM symbols.

48. The apparatus of claim 35, wherein the apparatus is further caused to:
transmit, to the network device, capability information related to the simultaneous SRS transmission on the set of one or more antenna ports at the apparatus.

49. An apparatus comprising:
at least one processor; and
at least one memory storing instructions that, when executed by the at least one processor, cause the apparatus at least to:
transmit, to a terminal device, a configuration of one or more uplink, UL, sounding reference signal, SRS, resources for simultaneous SRS transmission via a set of one or more antenna ports at the terminal device, wherein the set of one or more antenna ports associated with the one or more UL SRS resources correspond to one or more orthogonal frequency division multiplexing, OFDM, symbols; and
receive, from the terminal device, the simultaneous SRS transmission based on the configuration.

50. The apparatus of claim 49, wherein each UL SRS resource among the one or more UL SRS resources corresponds to a different OFDM symbol among the one or more OFDM symbols.

51. The apparatus of claim 49, wherein the set of one or more antenna ports comprises at least one antenna port coherency group, wherein each antenna port coherency group is associated with a UL SRS resource among the one or more UL SRS resources.

52. The apparatus of claim 51, wherein the apparatus is further caused to:
receive, from the terminal device, antenna port group coherency information comprising at least one of:
a number of antenna port coherency groups; or
a number of antenna ports per antenna port coherency group; and
determine the configuration at least based on the antenna port group coherency information.

53. The apparatus of claim 49, wherein the one or more UL SRS resources comprise a plurality of UL SRS resources comprising at least one UL SRS resource group and the one or more OFDM symbols comprise a plurality of OFDM symbols, wherein each UL SRS resource group among the at least one UL SRS resource group corresponds to a different OFDM symbol among the plurality of OFDM symbols.

54. A method comprising:
receiving, at a terminal device and from a network device, a configuration of one or more uplink, UL, sounding reference signal, SRS, resources for simultaneous SRS transmission via a set of one or more antenna ports at the terminal device, wherein the set of one or more antenna ports associated with the one or more UL SRS resources correspond to one or more orthogonal frequency division multiplexing, OFDM, symbols; and
transmitting, by the terminal device and to the network device, the simultaneous SRS transmission based on the configuration.
